(19) United States
(12) Patent Application Publication
(10) Pub. No.: US 2018/0098911 A1
(43) Pub. Date: Apr. 12, 2018

(54) DEVICE AND METHOD FOR CHEST PHYSIOTHERAPY TREATMENT

(71) Applicant: Sharon James, Mount Vernon, NY (US)

(72) Inventor: Sharon James, Mount Vernon, NY (US)

(21) Appl. No.: 15/289,086

(22) Filed: Oct. 7, 2016

(51) Int. Cl. A61H 23/06; A61H 1/00; A61H 23/00

(52) U.S. Cl. CPC A61H 23/06; A61H 1/008; A61H 2205/084; A61H 23/006; A61H 2205/081; A61H 23/004

(57) ABSTRACT

A hand held chest physiotherapy device comprises a hand grip member with a first end and a second end. The hand grip member is configured to adaptively receive a user hand via a strap member attached to a first end of the hand grip member. The second end of the hand grip member is removably attached to one or more venting members configured to incorporate a pressure difference in the device. The device further comprises a pad member, which is removably attached to an end of the venting members of the hand grip member. The pad member is configured to provide pressure on the patient by slapping the device against the chest or back of the patient.

### FIELD OF THE INVENTION

The present invention generally relates to a device and a method for treating external chest compression using a shock absorbing procedures. In particular, the present invention relates to the hand held chest physiotherapy device relieving user's lungs and respiratory system clogging from phlegm.

### BACKGROUND

Certain respiratory disorders, such as cystic fibrosis, emphysema, asthma, and chronic bronchitis, may cause mucous and other secretions to build up in a person's lungs. It is essential to remove the secretion build-up from the lungs to enable improved breathing. For example, chest physical therapy (CPT or Chest PT) is an airway clearance technique (ACT) to drain the lungs, and may include percussion (clapping), vibration, deep breathing and huffing or coughing. Different devices are used in place of the traditional cupped palm method for percussion where they consume lot of time. Generally treatment session will last between 20 to 40 minutes and can extend to hour.

There are a number of different devices and designs for performing chest physiotherapy and pulmonary percussion to help dislodge, and loosen secretions their mucus from the lungs and respiratory system. Traditional methods and devices to treat conditions and diseases such as asthma and cystic fibrosis, uses chest physiotherapy treatment for the reduction and removal of accumulated mucus. Some shock absorbing cushion devices were used for chest physiotherapy treatment. Such methods and devices were often primitive, and applied with higher physical force to achieve optimal efficacy, resulting in unwarranted physical injury to the patient undergoing treatment.

Existing prior arts uses a method of repeated squeezing, giving shock to the patient to release mucus from the entire chest region. Shock absorbing may be provided by a variety of means such as U.S. Pat. No. 6,428,865 (the '865 patent) issued to Huang is an exemplary application of such early forms of shock-absorbing cushion. This device is a molded shock-absorbing cushion device. This shock-absorbing cushion comprising two sheets peripherally sealed, a plurality of half-through holes and or grooves whose circumferential walls constitute a cubic supporting structure. The large contact area of this apparatus and similar devices made them unsuitable for the treatment of infants and young children whose soft bones and delicate skin rendered them susceptible to significant injury from repetitive engagement of this device.

U.S. Pat. No. 4,881,527 issued to Lerman describes a chamber which may be placed over a patient's chest to alternately apply pressure and force to compress and expand the chest. However, this device causes ineffective treatment of the suffering area and possible inflammation of the unaffected surrounding area causing pain to the user, and control of these devices are inherently difficult.

A wide variety of hand-held vibrators have been described for treating asthma, cystic fibrosis patients, and other respiratory ailment sufferers. Many of these hand-held units are not particularly portable, which possess a large external mechanical power source. Other existing approaches use the patient's breathing pressure creating vibrations, which are then transmitted down the patient's airways. This technique is limited by the strength and pressure at which the patient's breathe can oscillate.

There exists a need for hand held chest physiotherapy easy-to-use device, suitable for loosening phlegm from the lungs without causing any injury to the patient.

### SUMMARY

The present invention is generally directed to a device for performing chest physiotherapy for a patient. The hand held chest physiotherapy device comprises a hand grip member for portably handling the device. The hand grip member comprises a plurality of vents with a first end and a second end. The hand grip member is configured to adaptively receive a user hand via a strap member, which is attached to a first end of the hand grip member. The second end of the hand grip member is removably attached to one or more venting members configured to incorporate a pressure difference in the device. The hand held chest physiotherapy device comprises a plurality of pad members, which is removably attached to an end of the venting members of the hand grip member. The pad members of the hand held chest physiotherapy device are configured to provide pressure to the user.

In exemplary embodiment, the hand held chest physiotherapy device is a sheet material such as plastic, metal, or the like, which helps in generating pressure against the back or chest of the patient. The user could undergo chest physiotherapy using their hands in a gentle manner by slapping the back, or chest area with the device. The pad members of the device absorb shock, and provide force to help the user breath better as an asthma relief medication, or asthma relief breather. The hand held chest physiotherapy device reduces the risk of injury to the patient.

In a preferred aspect of this embodiment, the pad members of the hand held chest physiotherapy device is configured to have the dimension of 5 inches long and 4.5 inches wide, preferably being in the range from about 10 to 15 cm. For children, the dimensions vary accordingly. Preferably, the shape of the device is oval and non-circular geometries. The pad members could be shaped to provide a desired force distribution over the user' supper chest, and rear side for allowing the user to breath freely after providing sufficient shock or pressure.

In a preferred embodiment of this invention, the hand grip member material is selected from the group consisting of a santoprene, a neoprene, a butyl rubber, a nitrite rubber, a silicone rubber, or a combination thereof. The pad members are removably attached to the second end of the hand grip portion via a fastening member. The fastening member is selected from the group consisting of screws, bolts, and pins. The pad member material is selected from the group of material consisting of different hardness and sizes.

The foregoing has outlined, rather broadly, the preferred feature of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention and that such other structures do not depart from the spirit and scope of the invention in its broadest form.

### BRIEF DESCRIPTION OF DRAWINGS

FIG. 1 is an exploded view of a hand held chest physiotherapy device, according to one embodiment of the present invention.

FIG. 2 is a perspective view of the hand held chest physiotherapy device, according to another embodiment of the present invention.

FIG. 3 is the perspective side view of the hand held chest physiotherapy device on a patient, according to one embodiment of the present invention.

### DETAILED DESCRIPTION OF THE INVENTION

As required, detailed embodiments of the present invention are disclosed herein; however, it is to be understood that the disclosed embodiments are merely exemplary of the invention which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

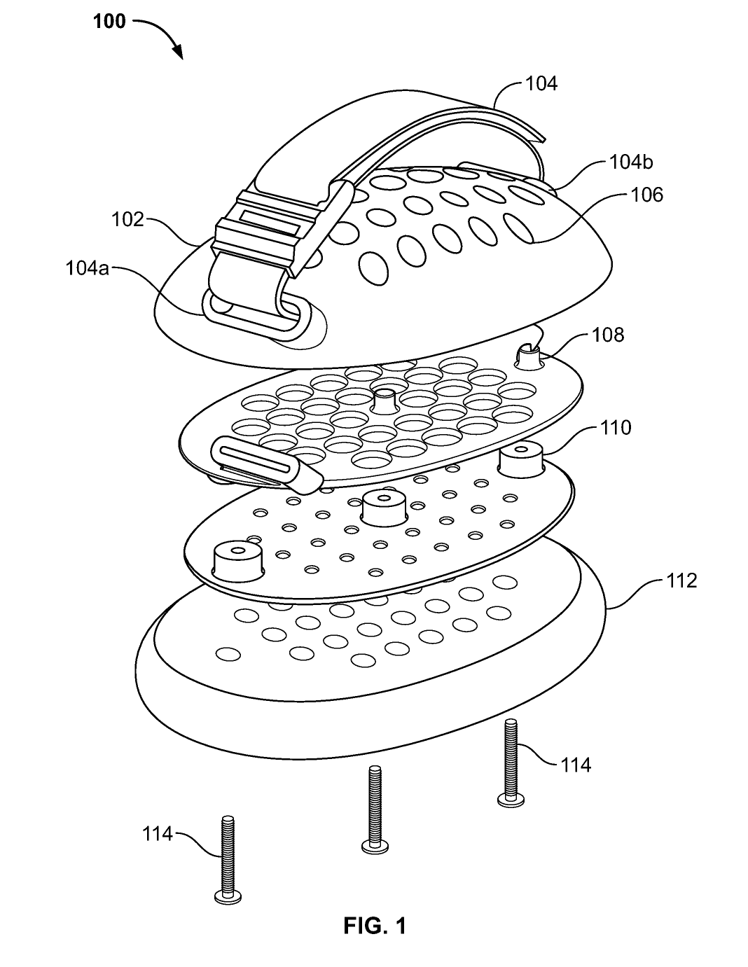

Referring now to FIG. 1, shows an exploded view of a hand held chest physiotherapy device 100, according to one embodiment of the present invention. The hand held chest physiotherapy device 100 is used for performing chest physiotherapy on a patient 118 in accordance with the principles of the invention. The hand held chest physiotherapy device 100 comprises a hand grip member 102 having a plurality of vents 106 with a first end 104a and a second end 104b. The hand grip member 102 is configured to adaptively receive a user hand 116 via a strap member 104, which is attached to a first end 104a of the hand grip member 102. The second end 104b of the hand grip member 102 is removably attached to one or more venting members 106 configured to incorporate a pressure difference in the device. The hand held chest physiotherapy device 100 comprises a plurality of pad members 112 which are removably attached to an end of the venting members 106 of the hand grip member 102. The pad members 112 of the hand held chest physiotherapy device 100 is configured to provide pressure to the patient 118.

In a preferred embodiment, the hand grip member 102 comprises a material selected from the group consisting of a santoprene, a neoprene, a butyl rubber, a nitrite rubber, a silicone rubber, or a combination thereof. The plurality of pad members 112 are removably attached to the second end of the hand grip member 102 via a fastening member (108 and 110). The fastening member (108 and 110) are selected from the group consisting of screws, bolts, and pins. The pad members 112 are selected from the group of material consisting of different hardness and sizes.

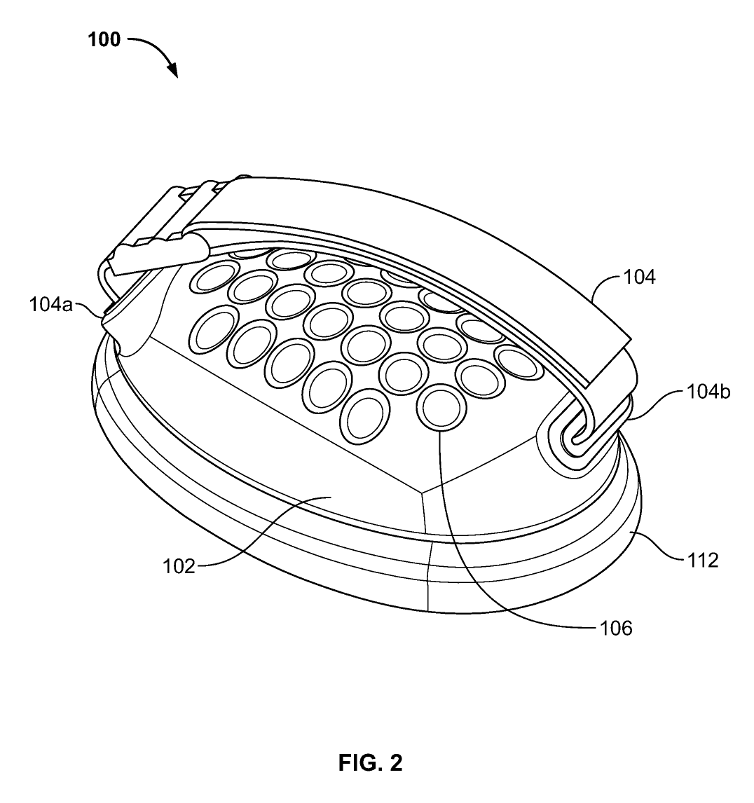

According to FIG. 2, shows a perspective view of the hand held chest physiotherapy device 100, according to another embodiment of the present invention. The pad members 112 are held in place and replaced over time, or exchanged with a replacement pad members based on the user requirement. The hand grip member 102 and pad members 112 are firmly screwed together in the device 100 with the three screws 114 (as shown in FIG. 1). The user using the device 100 provides pressure by multiple pushing to the upper chest and back of the patient 118 in order to loosen material in the lungs and respiratory system. The venting members 106 extend throughout the bottom or radially with an opening at the center. The strap member 104 is selected from at least one of a hook and loop fastener, a touch fastener, a clasp, a micro hook and a button. The pad members 112 include one or more claw members to engage with the hand grip member 102 via a snap locking assembly. The venting members 106 are removably attached to the hand grip member 102 via nails, screws, fastener pins, nuts and bolts, and combinations thereof. The pressure provided by the hand held chest physiotherapy device 100 is about 4 inches of pressure above atmospheric pressure. The hand grip member 102 of the hand held chest physiotherapy device 100 is made of a soft yieldable plastic with a thickness of about one millimeter. In a preferred embodiment, the hand grip member 102 is made of a tough plastic. In a preferred embodiment, the hand held chest physiotherapy device 100 is a lightweight, portable and inexpensive device for doctors, clinicians, professionals and consumers.

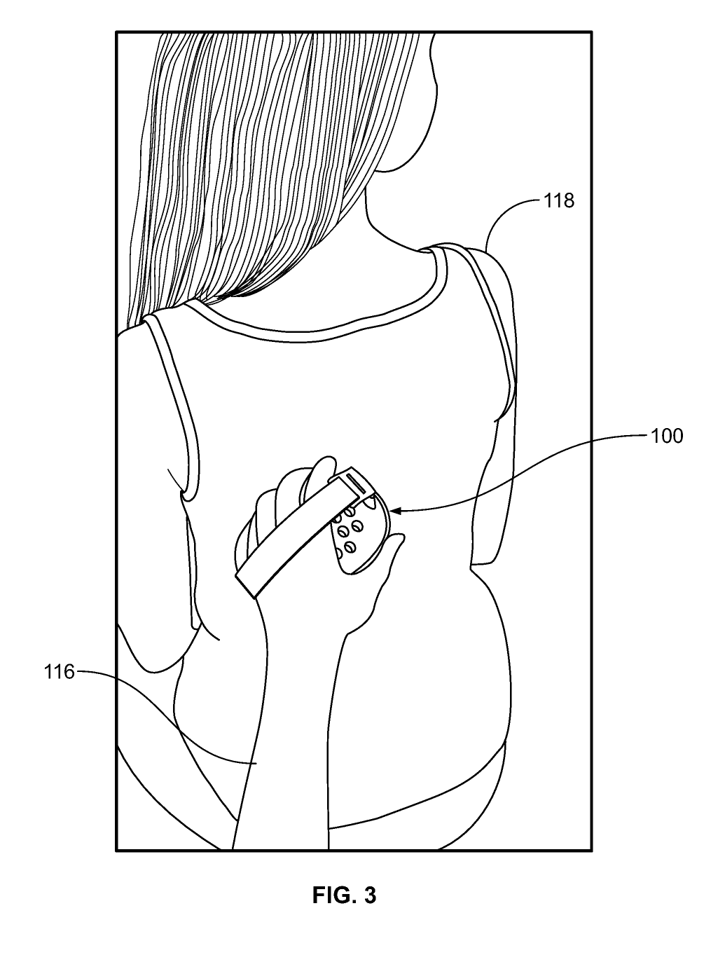

According to FIG. 3, shows the perspective side view of the hand held chest physiotherapy device 100 on a patient 118, according to one embodiment of the present invention. The hand held chest physiotherapy device 100 is designed to hold the strap member 104 around user hand 116 firmly. For an instance, when the hand held chest physiotherapy device 100 is applied to the back of the patient 118, the plurality of pad members 112 is pressed against the back or chest of the patient 118. In an embodiment, the hand held chest physiotherapy device 100 comprises a spring assembly (not shown in FIGs) inside the device, which absorbs more shock. The hand held chest physiotherapy device 100 is configured to impart a required amount of pressure to the back or chest of the patient 118 for performing chest physiotherapy. Air is also discharged from one or more venting members 106 to ensure a painless experience and additional softness to the patient 118. The combination of the spring assembly and air allows the hand held chest physiotherapy device 100 to function safely and effectively. The hand held chest physiotherapy (HHCPT) device 100 performs the process to loosen phlegm from the lungs by gently slapping the patient 118 using the hand held chest physiotherapy device 100 on the back, or chest area, by securely holding the hand grip member 102. The pad members 112 absorbs the amount of shock provided by the user's hand 112 and enough pressure is provided to improve the patient 118 breathing by applying it with other asthma relief medication or asthma relief inhaler.

The hand grip member 102 used in the hand held chest physiotherapy device 100 creates enough pressure or shock energy to be applied on patient 118 back and chest to achieve desired results. The strap member 104 allows to easily grip the hand held chest physiotherapy (HHCPT) device, which in return gives the patient 118 a more effective treatment.

Although the present invention has been described herein in the context of a particular implementation in a particular environment for a particular purpose, those of ordinary skill in the art will recognize that its usefulness is not limited thereto and that the present invention may be beneficially implemented in any number of environments for any number of purposes. Accordingly, the claims set forth below should be construed in view of the full breadth and spirit of the present invention as described herein. Although specific terms may be employed herein, they are used in a generic and descriptive sense only and not for purposes of limitation.

1. A hand held chest physiotherapy device comprising:
a hand grip member having a plurality of vents with a first end and a second end, said hand grip member is configured to adaptively receive a user's hand via a strap member attached to a first end of the hand grip member, wherein the second end of the hand grip member is removably attached to one or more venting members configured to incorporate a pressure difference in the device, and
a plurality of pad members are removably attached to an end of the venting members of the hand grip member, wherein the pad member is configured to provide pressure on the patient by slapping the device against the chest or back of the patient.

2. The hand held chest physiotherapy device of claim 1, wherein the hand grip member comprising a material selected from the group consisting of a santoprene, a neoprene, a butyl rubber, a nitrite rubber, a silicone rubber, or a combination thereof.

3. The hand held chest physiotherapy device of claim 1, wherein the pad members are removably attached to the second end of the hand grip portion via a fastening member.

4. The hand held chest physiotherapy device of claim 1, wherein the fastening member is selected from the group consisting of screws, bolts, and pins.

5. The hand held chest physiotherapy device of claim 1, wherein the pad members comprising a material is selected from the group consisting of different hardness and sizes.

6. The hand held chest physiotherapy device of claim 1, wherein the strap member is selected from at least one of a hook and loop fastener, a touch fastener, a clasp, a micro hook and a button.

7. The hand held chest physiotherapy device of claim 1, wherein the pad members includes one or more claw members to engage with the hand grip portion via a snap locking assembly.

8. The hand held chest physiotherapy device of claim 1, wherein the venting members is removable attached to the hand grip member via nails, screws, fastener pins, nuts and bolts, and combinations thereof.

9. The hand held chest physiotherapy device of claim 1, wherein the pressure is at least 4 inches of pressure.

10. The hand held chest physiotherapy device of claim 1, wherein the pressure is released through one or more venting members.

11. The hand held chest physiotherapy device of claim 1, wherein the hand grip member is a soft plastic.

12. The hand held chest physiotherapy device of claim 1, wherein the hand grip member is at least 1 mm of thickness.

13. The hand held chest physiotherapy device of claim 1, wherein the pad member base is at least 5 inches of length.

14. The hand held chest physiotherapy device of claim 1, wherein the pad member base is at least 4.5 inches of width.
